(19) United States
(12) Patent Application Publication
(10) Pub. No.: US 2026/0183948 A1
(43) Pub. Date: Jul. 2, 2026

(54) INFORMATION PROCESSING DEVICE AND INFORMATION PROCESSING METHOD

(71) Applicant: SONY GROUP CORPORATION, TOKYO (JP)

(72) Inventors: RYO TERASAWA, TOKYO (JP); YASUHIRO MATSUDA, TOKYO (JP); SATOKO MIZUTANI, TOKYO (JP); TOSHIMITSU TSUBOI, TOKYO (JP)

(21) Appl. No.: 18/866,296

(22) PCT Filed: Mar. 28, 2023
(86) PCT No.: PCT/JP2023/012619

§ 371 Date: Nov. 15, 2024

(30) Foreign Application Priority Data
May 24, 2022 (JP) 2022-084292

(51) Int. Cl. B25J 9/16; G06T 7/73

(52) U.S. Cl. CPC B25J 9/1664; G06T 7/73; G06T 2200/04; G06T 2207/30261

(57) ABSTRACT

[Problem] The redundancy of the orientation of an arm that satisfies the position and orientation of the hand tip of a manipulator is represented more accurately.

[Means of Solution] An information processing device includes: an angle sequence derivation unit that derives at least one or more joint angle sequences of a manipulator corresponding to each of small regions, obtained by dividing a task space of a robot, in dimensions of position and orientation of a hand tip of the manipulator of the robot; and a grouping unit that classifies, for each of the small regions, the joint angle sequences, corresponding to the small region, into at least one or more groups.

### TECHNICAL FIELD

The present disclosure relates to an information processing device and an information processing method.

### BACKGROUND ART

In a multi-joint robot, the degrees of freedom of the orientation of the arm of a manipulator may be higher than the degrees of freedom (six degrees of freedom) of the position and orientation of the hand tip of the manipulator. In such a case, the multi-joint robot is allowed to change the orientation of the arm of the manipulator in various ways with respect to one position and orientation of the hand tip. A multi-joint robot can perform tasks while avoiding interference between a manipulator thereof and surrounding objects, even in relatively narrow spaces, by appropriately controlling the redundant degrees of freedom of the arm of the manipulator.

PTL 1 listed below discloses that small regions that a manipulator can reach and parameters of the joints of the manipulator in the small regions are set in advance in a redundant angle definition table. According to the technology disclosed in PTL 1, the angle of the redundant axis of the manipulator can be determined more quickly.

### CITATION LIST

### Patent Literature

### [PTL 1]

JP 2012-51043 A

### SUMMARY

### Technical Problem

However, in the technology disclosed in PTL 1, there is a one-to-one correspondence between small regions and parameters of the joints of the manipulator. Therefore, with the technology disclosed in PTL 1, it is difficult to utilize the redundancy to flexibly control the orientation of the arm of the manipulator in accordance with the positional relationship with surrounding objects.

Therefore, in order to more effectively utilize the redundancy in the orientation of the arm of the manipulator, there is a need for a technology that can more accurately represent the degree of redundancy in the orientation of the arm that satisfies the position and orientation of the hand tip of the manipulator.

### Solution to Problem

According to the present disclosure, an information processing device is provided, including: an angle sequence derivation unit that derives at least one or more joint angle sequences of a manipulator corresponding to each of small regions, obtained by dividing a task space of a robot, in dimensions of position and orientation of a hand tip of the manipulator of the robot; and a grouping unit that classifies, for each of the small regions, the joint angle sequences, corresponding to the small region, into at least one or more groups.

According to the present disclosure, an information processing method is provided, including: by a computing device, deriving at least one or more joint angle sequences of a manipulator corresponding to each of small regions, obtained by dividing a task space of a robot, in dimensions of position and orientation of a hand tip of the manipulator of the robot; and classifying, for each of the small regions, the joint angle sequences, corresponding to the small region, into at least one or more groups.

### BRIEF DESCRIPTION OF DRAWINGS

FIG. 1 is a schematic diagram illustrating an overview of a robot to which the technology according to the present disclosure is applied.

FIG. 2 is a block diagram illustrating a functional configuration of an information processing device according to a first embodiment.

FIG. 3 is an explanatory diagram for explaining division of a task space of a robot.

FIG. 4 is a schematic diagram illustrating an example of classifying a joint angle sequence into a group by a grouping unit.

FIG. 5 is a schematic diagram illustrating a correspondence relationship between a task space corresponding to positions and orientations of a hand tip of the robot and a joint space corresponding to joint angle sequences of an arm.

FIG. 6 is a flowchart illustrating an example of an operation of the information processing device according to the first embodiment.

FIG. 7 is a block diagram illustrating a functional configuration of an information processing device according to a second embodiment.

FIG. 8 is a schematic diagram illustrating generation of an inverse reachable range map.

FIG. 9 is a block diagram illustrating a functional configuration of an information processing device according to a third embodiment.

FIG. 10 is an explanatory diagram illustrating an example of a graph structure generated by a graph generation unit.

### DESCRIPTION OF EMBODIMENTS

Preferred embodiments of the present disclosure will be described in detail with reference to the accompanying figures below. Also, in the present specification and the figures, components having substantially the same functional configuration will be denoted by the same reference numerals, and thus repeated descriptions thereof will be omitted.

The description will be given in the following order.
1. First Embodiment
1.1. Configuration of Robot
1.2. Configuration of Information Processing Device
1.3. Operation of Information Processing Device
2. Second Embodiment
2.1. Configuration of Information Processing Device
3. Third Embodiment
3.1. Configuration of Information Processing Device

### 1. First Embodiment

### (1.1. Configuration of Robot)

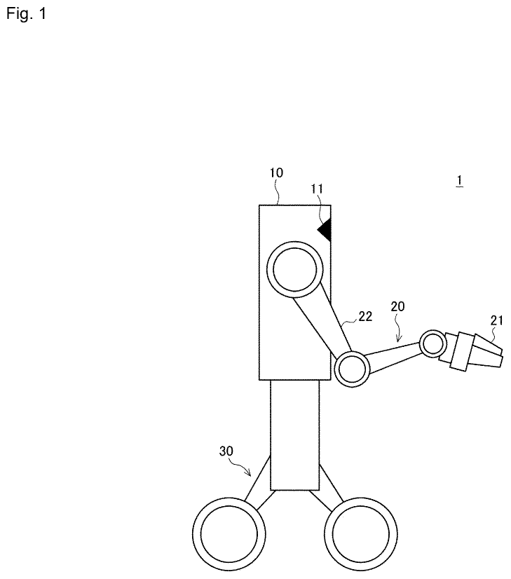

First, a robot to which the technology according to the present disclosure is applied will be described with reference to FIG. 1. FIG. 1 is a schematic diagram illustrating an overview of the robot 1 to which the technology according to the present disclosure is applied.

As illustrated in FIG. 1, the robot 1 includes a main body 10, a manipulator 20, and a moving mechanism 30. However, the robot 1 may be fixed at a predetermined position instead of including the moving mechanism 30.

The main body 10 corresponds to the torso of the robot 1. The main body 10 is provided with a sensor 11, the manipulator 20, and the moving mechanism 30. The main body 10 is also provided with a control device that controls the overall operation of the robot 1, a power supply device that supplies power to each part of the robot 1, and the like.

The sensor 11 is provided on the vertical upper side of the main body 10 to sense the environment around the robot 1. The robot 1 can control the driving of the manipulator 20 and the moving mechanism 30 based on a sensing result by the sensor 11. The sensor 11 may be, for example, an infrared time of flight (ToF) sensor, a light detection and ranging (LiDAR), a radio detecting and ranging (Radar), an ultrasonic sensor, or a distance measurement sensor that measures the distance to an object, such as a stereo camera. The sensor 11 may be a camera that captures an image of the environment around the robot 1, such as an RGB camera, a stereo camera, an infrared (IR) camera, or a thermal camera.

The manipulator 20 has an arm 22 and a hand tip 21 provided at the tip of the arm 22, and is provided vertically above the main body 10. The arm 22 is configured with a link mechanism including a plurality of links and a plurality of joints that connect the plurality of links to each other. The hand tip 21 is attached to the tip of the arm 22 to perform, for example, grasping an object present in the surrounding environment. The hand tip 21 may be, for example, a hand having a plurality of fingers, a gripper having a plurality of claws, a suction hand using air or magnetic force, or a hook of various shapes. By driving the manipulator 20, the robot 1 can act on an object present in the surrounding environment.

The moving mechanism 30 is provided vertically below the main body 10 to move the robot 1 to any position. The moving mechanism 30 may be any moving mechanism including two or more wheels, two or more legs, crawlers, air cushions, or rotors, which are capable of moving the robot 1.

### (1.2. Configuration of Information Processing Device)

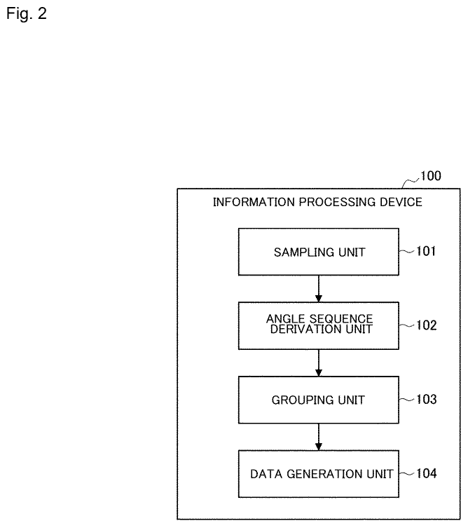

Next, a configuration of an information processing device according to the first embodiment of the present disclosure will be described with reference to FIG. 2. FIG. 2 is a block diagram illustrating a functional configuration of the information processing device 100 according to the present embodiment.

As illustrated in FIG. 2, the information processing device 100 includes a sampling unit 101, an angle sequence derivation unit 102, a grouping unit 103, and a data generation unit 104. The information processing device 100 according to the present embodiment can generate data that takes into account the redundancy of the arm 22 of the manipulator 20 for each of small regions that the hand tip 21 of the manipulator 20 of the robot 1 can reach.

The sampling unit 101 randomly samples a joint angle sequence of the arm 22 in the state where the robot 1 and a base link of the arm 22 are fixed. The joint angle sequence of the arm 22 is, for example, a sequence of angles of the joints of the arm 22 of the manipulator 20 arranged in order from the main body 10 side. If the sampled joint angle sequence causes auto-interference of the arm 22 of the manipulator 20, the sampling unit 101 resamples the joint angle sequence of the arm 22.

The angle sequence derivation unit 102 derives a small region, of the task space of the robot 1, corresponding to the sampled joint angle sequence of the arm 22. The task space is a space corresponding to positions and orientations of the hand tip 21 of the manipulator 20 provided in the robot 1. The angle sequence derivation unit 102 derives a position and an orientation of the hand tip 21 determined by the sampled joint angle sequence of the arm 22 by forward kinematics calculation, and determines a region corresponding to the derived position and orientation of the hand tip 21 as the small region corresponding to the sampled joint angle sequence of the arm 22.

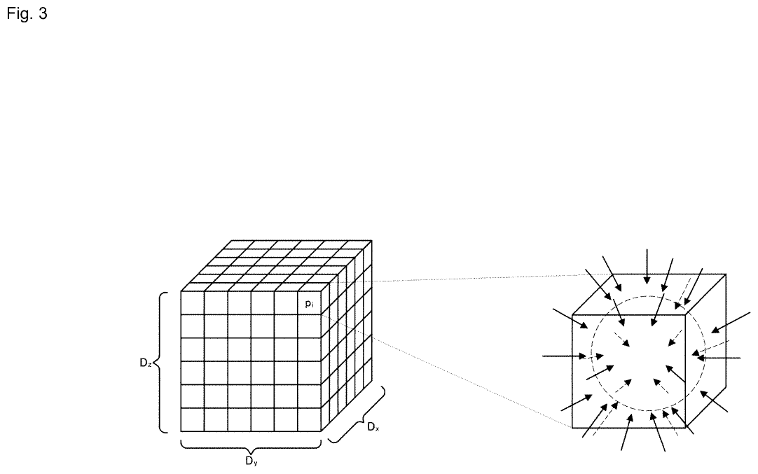

The task space of the robot 1 and the small regions into which the task space is divided will now be described with reference to FIG. 3. FIG. 3 is an explanatory diagram for explaining division of the task space of the robot 1.

As illustrated in FIG. 3, the task space of the robot 1 is first divided into grids based on possible three dimensional positions of the hand tip 21. Each of the divided grids is further divided based on possible three dimensional orientations of the hand tip 21. Specifically, the task space of the robot 1 is first divided into equal Dₓ, D_{y}, and D_{z} parts in x-axis, y-axis, and z-axis directions, respectively, for positions p(x, y, z) of the hand tip 21.

An orientation e of the hand tip 21 is represented, for example, by Z-Y-X Euler angles. Each of the divided grids for positions p (x, y, z) of the hand tip 21 is divided into D_{φ} parts and D_{θ} parts on a spherical surface, and then divided into D_{ψ} parts around the axis of a vector from each divided region to the center of the sphere. As a result, a divided grid for a position p (x, y, z) of the hand tip 21 is divided into D_{φ}, D_{θ}, and D_{ψ} parts around the x-axis, y-axis, and z-axis, respectively, for an orientation e (roll, pitch, yaw) of the hand tip 21.

A small region of the task space described above can be represented as six-dimensionally discretized voxel data of a position and an orientation of the hand tip 21. In other words, a small region of the task space can be represented as hierarchical six-dimensional voxel data in which a three-dimensional voxel of position further contains a three-dimensional voxel of orientation. As will be described later, in the small region (i, j) of the divided i-th position pᵢ (0≤i<Dₓ*D_{y}*D_{z}) and the j-th orientation eⱼ (0≤j<D_{φ}*D_{θ}*D_{ψ}), data r_{i,j} is stored such as a representative value of the arm 22 that can reach the corresponding position and orientation of the hand tip 21.

The sampling unit 101 and the angle sequence derivation unit 102 repeatedly perform sampling of a joint angle sequence of the arm 22 and derivation of a small region corresponding to the sampled joint angle sequence until a sufficient amount of data is collected. As a result, each of the small regions of the task space of the robot 1 is associated with at least one or more joint angle sequences of the arm 22 that satisfies the position and orientation of the hand tip 21 corresponding to the small region.

The grouping unit 103 classifies, for each small region, the joint angle sequence(s) corresponding to that small region into a group(s). Specifically, the grouping unit 103 classifies, for each small region, the joint angle sequence(s) corresponding to that small region into a group(s) based on similarities between joint angle sequences. As an example, the grouping unit 103 may classify the joint angle sequence(s) into a group(s) by using clustering processing. For example, the grouping unit 103 may perform the clustering processing using a combination of the k-means++ method and the elbow method, or may perform the clustering processing using the x-means method in which the number of clusters is automatically set. As another example, the grouping unit 103 may classify the joint angle sequence(s) into a group(s) based on a predetermined rule.

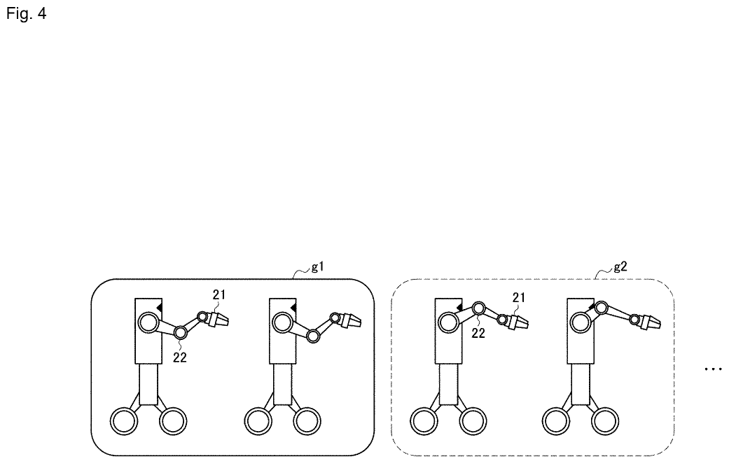

This enables the grouping unit 103 to classify a plurality of joint angle sequences that satisfy the same position and orientation of the hand tip 21 into a group(s) based on the orientation of the arm 22 as illustrated in FIG. 4. FIG. 4 is a schematic diagram illustrating an example of classifying a joint angle sequence into a group by the grouping unit 103. In FIG. 4, the grouping unit 103 classifies joint angle sequences in which the arm 22 bends in the same direction into the same group. Specifically, for the same position and orientation of the hand tip 21, the grouping unit 103 classifies the joint angle sequences in which the arm 22 bends convexly vertically downward into a first group g1, and classifies the joint angle sequences in which the arm 22 bends convexly vertically upward into a second group g2.

The data generation unit 104 assigns, for each small region, identification information to each of the groups for the classification performed by the grouping unit 103, and creates a list including a set of a representative value of the group and the identification information. The data generation unit 104 also stores the listed data r_{i, j} in each of the small regions. For example, the data generation unit 104 may store data r_{i, j} of the following Equation 1 in each of the small regions. In Equation 1, Iₖ is the identification information of a group, and r_{i, j}^{k} is the representative value of the group.

$$[ Math . 1 ]$$

$${r}_{i , j} = [ [ {I}_{0} , {r}_{i , j}^{0} ] , … [ {I}_{k} , {r}_{i , j}^{k} ] , … ] \qquad ( Equation 1 )$$

The identification information is a code for distinguishing the groups. For example, the identification information may be an integer such as “0, 1, 2, . . . ” or may be an alphabet such as “A, B, C, . . . ”. The representative value is a value that represents the joint angle sequence that belongs to the corresponding group, and is derived based on the joint angle sequence that belongs to the group. For example, the representative value may be the maximum manipulability of the joint angle sequence that belongs to the corresponding group. However, the representative value may be any value as long as it represents the joint angle sequence that belongs to the corresponding group. The representative value may be a value derived from the joint angle sequence that belongs to the corresponding group using machine learning or the like, or may be any value set by the user from the joint angle sequence that belongs to the corresponding group.

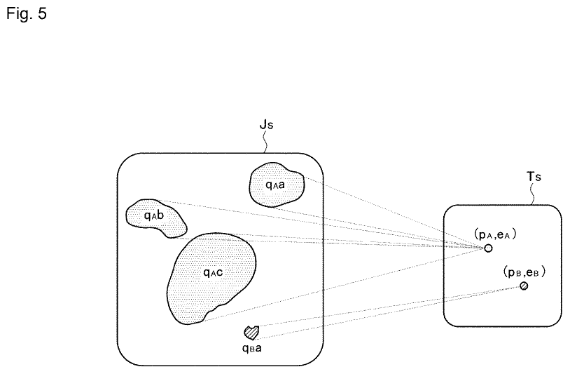

The grouping unit 103 and the data generation unit 104 will now be described in more detail with reference to an example illustrated in FIG. 5. FIG. 5 is a schematic diagram illustrating an example of a correspondence relationship between a task space Ts corresponding to positions and orientations of the hand tip 21 of the robot 1 and a joint space Js corresponding to joint angle sequences of the arm 22.

As illustrated in FIG. 5, for each of positions and orientations (p_{A}, e_{A}, (p_{B}, e_{B}) of the hand tip 21 in the task space Ts, it is assumed that joint angle sequences of the arm 22 that satisfy the positions and orientations (p_{A}, e_{A}, (p_{B}, e_{B}) of the hand tip 21 exist in the joint space Js. It is assumed that the region of the joint angle sequence that satisfies the position and orientation (p_{A}, e_{A}) of the hand tip 21 is larger than the region of the joint angle sequence that satisfies the position and orientation (p_{B}, e_{B}) of the hand tip 21.

In such a case, the grouping unit 103 can classify the joint angle sequences that satisfy the position and orientation (p_{A}, e_{A}) of the hand tip 21 into three groups q_{A}a, q_{A}b, and q_{A}c. The grouping unit 103 can also classify the joint angle sequences that satisfy the position and orientation (p_{B}, e_{B}) of the hand tip 21 into one group q_{B}a.

The data generation unit 104 can generate data r_{A, A} of a small region corresponding to the position and orientation (p_{A}, e_{A}) of the hand tip 21 as represented in the following Equation 2 by assigning identification information of “0”, “1”, and “2” to the three groups q_{A}a, q_{A}b, and q_{A}c, respectively. Here, r_{A, A}^{a}, r_{A, A}^{b}, and r_{A, A}^{c} are representative values of the groups q_{A}a, q_{A}b, and q_{A}c, respectively.

$$[ Math . 2 ]$$

$${r}_{A , A} = [ [ 0 , {r}_{A , A}^{a} ] , [ 1 , {r}_{A , A}^{b} ] , [ 2 , {r}_{A , A}^{c} ] \qquad ( Equation 2 )$$

In addition, the data generation unit 104 can generate data r_{B, B} of a small region corresponding to the position and orientation (p_{B}, e_{B}) of the hand tip 21 as represented in the following Equation 3 by assigning identification information of “0” to one group q_{B}a. Here, r_{B, B}^{a} is a representative value of the group q_{B}a.

$$[ Math . 3 ]$$

$${r}_{B , B} = [ [ 0 , {r}_{B , B}^{a} ] ] \qquad ( Equation 3 )$$

As illustrated in the above example, the information processing device 100 according to the present embodiment can classify the joint angle sequence(s) of the arm 22 that satisfy the position and orientation of the hand tip 21 into a group(s) for each small region corresponding to the position and orientation of the hand tip 21. This enables the information processing device 100 to represent the redundant degrees of freedom of the arm 22 for the position and orientation of the hand tip 21 as the number of groups of small regions. Therefore, the information processing device 100 can more accurately represent the redundancy of the orientation of the arm 22 that satisfies the position and orientation of the hand tip 21 of the manipulator 20.

The various types of functions of the information processing device 100 described above can be implemented by cooperation between software and hardware. For example, the functions of the sampling unit 101, the angle sequence derivation unit 102, the grouping unit 103, and the data generation unit 104, which are described above, may be implemented by hardware such as a central processing unit (CPU), a read only memory (ROM), and a random access memory (RAM). However, the information processing device 100 may have other hardware such as a digital signal processor (DSP) or an application specific integrated circuit (ASIC) instead of or in addition to the CPU.

The CPU functions as a computing device or a control device to control the operation of the information processing device 100 in accordance with various programs recorded in the ROM or RAM. The ROM stores programs used by the CPU, computation parameters, and the like. The RAM temporarily stores programs used in execution by the CPU, parameters used during the execution of the programs, and the like. The information processing device 100 can implement the various types of functions described above by executing software including various programs recorded in the ROM or RAM by the CPU.

### (1.3. Operation of Information Processing Device)

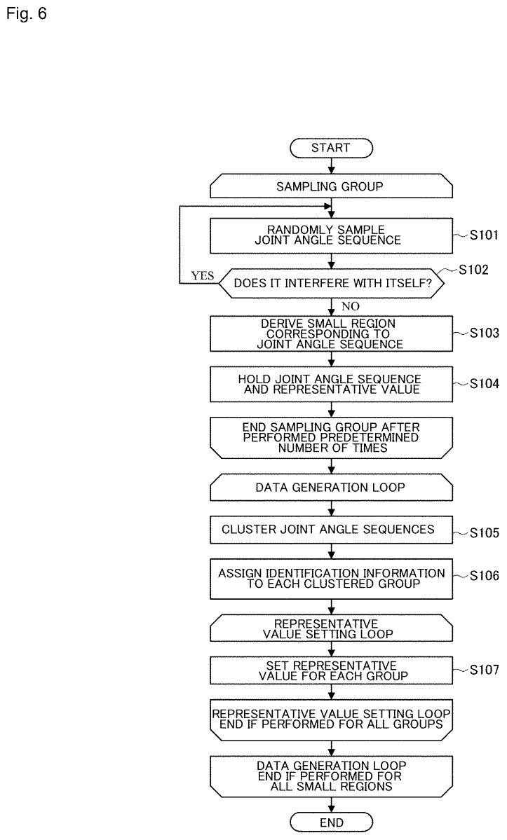

Subsequently, an operation of the information processing device 100 according to the present embodiment will be described with reference to FIG. 6. FIG. 6 is a flowchart illustrating an example of the operation of the information processing device 100 according to the present embodiment.

As illustrated in FIG. 6, the information processing device 100 first performs a sampling loop by the sampling unit 101 and the angle sequence derivation unit 102.

Specifically, the sampling unit 101 randomly samples a joint angle sequence of the arm 22 in the state where the base link of the arm 22 is fixed (S101). Next, the sampling unit 101 determines whether or not the sampled joint angle sequence causes auto-interference of the arm 22 (S102). If the sampled joint angle sequence causes auto-interference of the arm 22 (S102/Yes), the sampling unit 101 discards the sampled joint angle sequence and repeats the random sampling of a joint angle sequence (S102).

On the other hand, if the sampled joint angle sequence does not cause auto-interference of the arm 22 (S102/No), the angle sequence derivation unit 102 derives a position and an orientation of the hand tip 21 corresponding to the sampled joint angle sequence based on forward kinematics. After that, the angle sequence derivation unit 102 determines a small region corresponding to the derived position and orientation of the hand tip 21 as a small region corresponding to the sampled joint angle sequence of the arm 22 (S103). Furthermore, the angle sequence derivation unit 102 derives a representative value of the joint angle sequence, and holds the small region, the joint angle sequence, and the representative value in association with each other (S104).

The sampling unit 101 and the angle sequence derivation unit 102 repeatedly perform the above-described sampling loop operation (S101 to S104) until the sampling is performed a predetermined number of times.

Subsequently, the information processing device 100 causes the grouping unit 103 and the data generation unit 104 to perform a data generation loop.

Specifically, the grouping unit 103 classifies, for each small region, the joint angle sequence(s) corresponding to the small region into a group(s) by clustering (S105). Subsequently, the data generation unit 104 assigns identification information to each of the clustered groups (S106).

Next, the data generation unit 104 determines, as a representative value setting loop, a representative value for each group from the representative values of the joint angle sequences that belong to the group, and creates a list including a set of the determined representative value and the identification information (S107). The data generation unit 104 performs creating a list (S107) described above for all groups. As a result, for one small region, data is generated in which a list is created including a set of identification information and a representative value for each group.

After that, the grouping unit 103 and the data generation unit 104 perform the above-described data generating loop operation (S105 to S107) for all the small regions.

Thus, the information processing device 100 can generate data in which the joint angle sequence(s) of the arm 22 that satisfy the position and orientation of the hand tip 21 are classified into at least one or more groups for each small region corresponding to each of the positions and orientations of the hand tip 21.

### 2. Second Embodiment

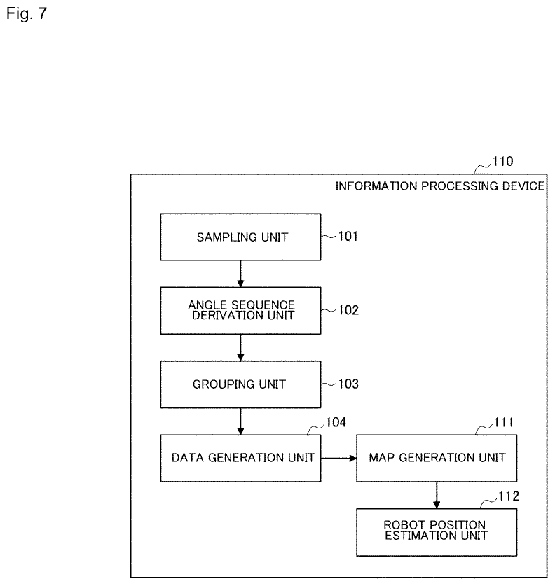

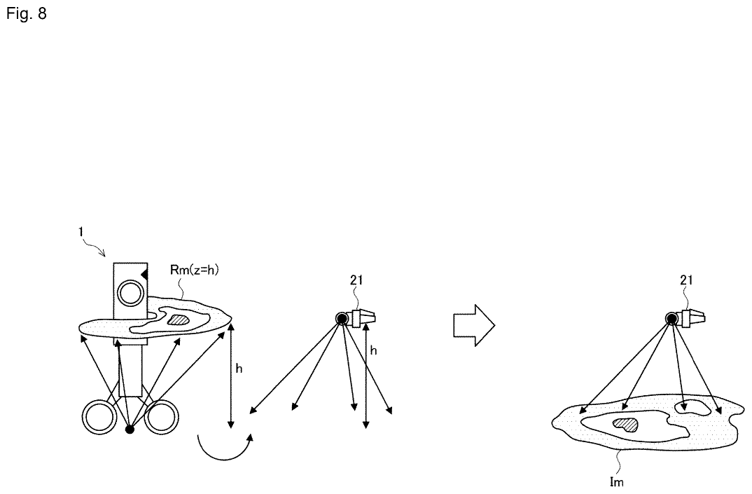

(2.1. Configuration of Information Processing Device) Next, a configuration of an information processing device 110 according to a second embodiment of the present disclosure will be described with reference to FIGS. 7 and 8. FIG. 7 is a block diagram illustrating a functional configuration of the information processing device 110 according to the present embodiment.

As illustrated in FIG. 7, the information processing device 110 includes a sampling unit 101, an angle sequence derivation unit 102, a grouping unit 103, a data generation unit 104, a map generation unit 111, and a robot position estimation unit 112.

The information processing device 110 according to the second embodiment differs from the information processing device 100 according to the first embodiment in that it further includes the map generation unit 111 and the robot position estimation unit 112. The information processing device 110 according to the second embodiment can estimate an optimal position of the robot 1 that can reach the target position and orientation of the hand tip 21 based on the data generated by the data generation unit 104.

The sampling unit 101, the angle sequence derivation unit 102, the grouping unit 103, and the data generation unit 104 are the same as those described in the first embodiment, and therefore description thereof will be omitted here.

The map generation unit 111 generates a reachable range map indicating small regions that the hand tip 21 of the manipulator 20 can reach, based on the data generated by the data generation unit 104. Specifically, the map generation unit 111 first obtains a representative value v_{i,j} of a small region (i, j) by calculating a sum of representative values r_{i, j}^{k} of groups included in data r_{i,j} stored in small regions (i, j), as illustrated in the following Equation 4. Next, the map generation unit 111 can generate a reachable range map by mapping a distribution of the representative values v_{i,j} of the small regions (i, j) as a heat map.

$$[ Math . 4 ]$$

$${v}_{i , j} = {\sum }_{k} {r}_{l , j}^{k} \qquad ( Equation 4 )$$

In such a reachable range map, the smaller the small region (i, j) is in which the arm 22 has a higher redundant degree of freedom and which has a larger number of groups of joint angle sequences that satisfy the position and orientation of the hand tip 21, the more the representative values r_{i, j}^{k} are added. Therefore, the representative value v_{i,j} has a larger value. Furthermore, when the representative value r_{i, j}^{k} of each group is the maximum manipulability of the joint angle sequence(s) that belong to that group, the higher the manipulability of an orientation of the small region (i, j) that the arm 22 can reach, the larger the value of the representative value v_{i,j} is. Therefore, by referring to the reachable range map generated by the map generation unit 111, the robot 1 can grasp the position and orientation of the hand tip 21 that the arm 22 can reach in an orientation having higher redundancy.

The robot position estimation unit 112 generates an inverse reachable range map by inversely transforming the reachable range map, thereby estimating the optimal position of the robot 1 that can reach the target position and orientation of the hand tip 21.

A specific operation of the robot position estimation unit 112 will be described with reference to FIG. 8. FIG. 8 is a schematic diagram illustrating generation of the inverse reachable range map.

As illustrated in FIG. 8, the robot position estimation unit 112 first acquires a reachable range map Rm that corresponds to the height and orientation angle of the target hand tip 21. The reachable range map Rm is a map of only a small region, having the same height as a height h of the target hand tip 21 and has an orientation close to the pitch angle and roll angle of the target hand tip 21, extracted from the reachable range map generated by the map generation unit 111.

Next, the robot position estimation unit 112 generates an inverse reachable range map Im by inversely transforming each of the small regions of the reachable range map Rm. Specifically, the robot position estimation unit 112 inversely transforms the position and orientation of each small region of the reachable range map Rm from the position and orientation of the hand tip 21 based on the robot 1 to the position and orientation of the robot 1 based on the hand tip 21. This enables the robot position estimation unit 112 to generate an inverse reachable range map Im that indicates the positions of the robot 1 that can reach the target position and orientation of the hand tip 21.

In the inverse reachable range map Im, the data r_{i, j} stored in each small region of the reachable range map Rm is stored as is in the corresponding small region (i, j) whose position and orientation have been inversely transformed. When a plurality of small regions of the reachable range map Rm are inversely transformed into the same small region of the inverse reachable range map Im, the data r_{i, j} stored in the plurality of small regions of the reachable range map Rm are integrated and stored in one small region of the inverse reachable range map Im.

This enables the robot position estimation unit 112 to compare the redundancy of small regions in the same manner as the reachable range map Rm by comparing the representative value of the small region, which is the sum of the representative values of the groups included in the small regions of the inverse reachable range map Im. In other words, the representative value of a small region is the sum of the representative values of the groups included in the small region, and therefore the greater the number of groups included in the small region, the greater the value. Therefore, the robot position estimation unit 112 can estimate a small region of the inverse reachable range map Im having the larger representative value as the optimal position of the robot 1 that has a larger variety of joint angle sequences that satisfy the target position and orientation of the hand tip 21.

With the above-described configuration, the information processing device 110 of the second embodiment can generate a reachable range map indicating the redundancy of the orientations of the arm 22 that can reach each of the small regions by using the data generated by the data generation unit 104. In addition, the information processing device 110 generates an inverse reachable range map by inversely transforming the reachable range map, thereby making it possible to estimate the optimal position of the robot 1 that will result in greater redundancy of the orientation of the arm 22 that achieves the target position and orientation of the hand tip 21.

### 3. Third Embodiment

### (3.1. Configuration of Information Processing Device)

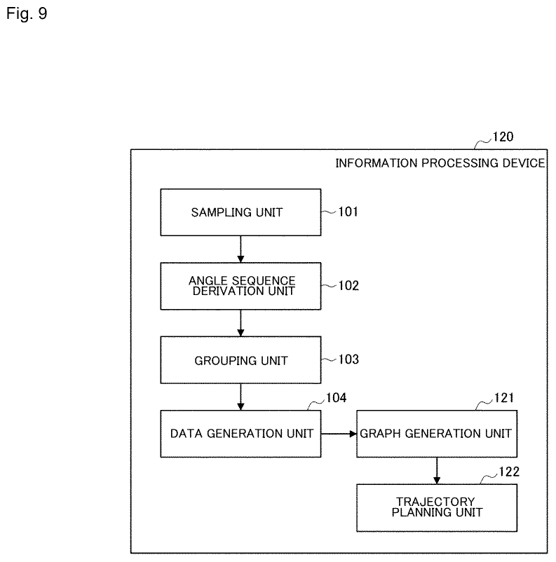

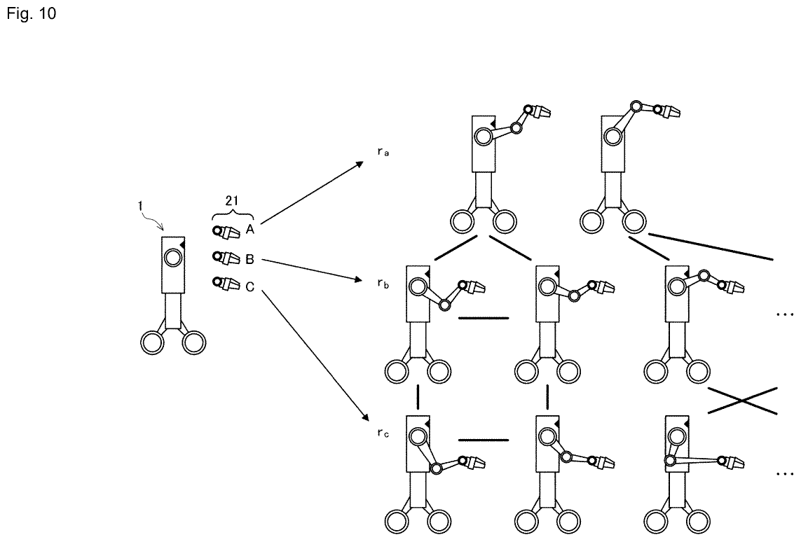

Subsequently, a configuration of an information processing device 120 according to a third embodiment of the present disclosure will be described with reference to FIGS. 9 and 10. FIG. 9 is a block diagram illustrating a functional configuration of the information processing device 120 according to the present embodiment. FIG. 10 is an explanatory diagram illustrating an example of a graph structure generated by a graph generation unit 121.

As illustrated in FIG. 9, the information processing device 120 includes a sampling unit 101, an angle sequence derivation unit 102, a grouping unit 103, a data generation unit 104, a graph generation unit 121, and a trajectory planning unit 122.

The information processing device 120 according to the third embodiment differs from the information processing device 100 according to the first embodiment in that it further includes the graph generation unit 121 and the trajectory planning unit 122. The information processing device 120 according to the third embodiment can plan a motion trajectory of the manipulator 20 at higher speed by generating a graph structure of the data generated by the data generation unit 104 and searching the graph structure.

The sampling unit 101, the angle sequence derivation unit 102, and the grouping unit 103 are the same as those described in the first embodiment, and therefore description thereof will be omitted here.

The data generation unit 104 creates, for each small region, a list including a set of identification information of a classified group, the representative value, and even the joint angle sequence corresponding to the representative value. The data generation unit 104 also stores the list of data r_{i, j} in each of the small regions. For example, the data generation unit 104 may store data r_{i, j} of the following Equation 5 in each of the small regions. In Equation 5, Iₖ is the identification information of a group, r_{i, j}^{k} is the representative value of the group, and qₖ is the joint angle sequence having the representative value r_{i, j}^{k}.

$$[ Math . 5 ]$$

$${r}_{i , j} = [ [ {I}_{0} , {r}_{i , j}^{0} , {q}_{0} ] , … [ {I}_{k} , {r}_{i , j}^{k} , {q}_{k} ] , … ] \qquad ( Equation 5 )$$

The graph generation unit 121 generates a graph structure in which the joint angle sequences having representative values of the groups included in the small regions are used as nodes. Specifically, the graph generation unit 121 sets the joint angle sequences having the representative values of the groups included in each small region as nodes, and connects the nodes of the joint angle sequences whose difference within and between small regions is equal to or less than a threshold value by edges. This enables the graph generation unit 121 to generate a graph structure in which the nodes of the joint angle sequences are connected by edges.

For example, the graph generation unit 121 may generate a graph structure as illustrated in FIG. 10. In FIG. 10, small regions r_{A}, r_{B}, and r_{C} are set for positions and orientations A, B, and C of the hand tip 21, respectively. The graph generation unit 121 may generate a graph structure by connecting, by edges, the joint angle sequences of each group within the small regions r_{A}, r_{B}, and r_{C}, and the joint angle sequences of each group between the small regions r_{A} and r_{B}. In the graph structure generated by the graph generation unit 121, the joint angle sequences whose differences are equal to or less than a threshold value are connected by edges. Therefore, the information processing device 120 can derive a transition paths of the joint angle sequences that allow the orientation of the arm 22 to transition smoothly by tracing the graph structure.

The trajectory planning unit 122 uses the graph structure generated by the graph generation unit 121 to derive a motion trajectory that reaches from an initial joint angle sequence to a target joint angle sequence. For example, when the trajectory planning unit 122 derives a trajectory of the position and orientation of the hand tip 21 that avoids an obstacle, the trajectory planning unit 122 can determine, by searching the graph structure, whether or not there is a path of a joint angle sequence that satisfies the derived position and orientation of the hand tip 21 and does not interfere with the obstacle.

Considering the position and orientation of the hand tip 21 in the task space allows the degree of freedom to be reduced, making it possible to intuitively avoid obstacles. Therefore, the trajectory planning unit 122 first searches for the trajectory of the position and orientation of the hand tip 21 in the task space, and then searches for the trajectory of the joint angle sequence using the above-described graph structure, thereby making it possible to derive the motion trajectory of the manipulator 20 more quickly. In addition, since the trajectory planning unit 122 can more appropriately plan the motion trajectory of the orientation of the arm 22, it is possible to further reduce the number of times that the arm 22 of the manipulator 20 detects a collision with an obstacle.

With the above-described configuration, the information processing device 120 according to the third embodiment can generate a graph structure in which joint angle sequences having representative values in each group included in small regions are connected by edges by using the data generated by the data generation unit 104. This enables the information processing device 120 to plan a motion trajectory of the manipulator 20 at higher speed by searching the generated graph structure.

Although the preferred embodiments of the present disclosure have been described in detail with reference to the accompanying figures as described above, the technical scope of the present disclosure is not limited to such examples. It is apparent that those having ordinary knowledge in the technical field of the present disclosure could conceive various modified examples or changed examples within the scope of the technical ideas set forth in the claims, and it should be understood that these also naturally fall within the technical scope of the present disclosure.

Further, the effects described in the present specification are merely explanatory or exemplary and are not intended as limiting. That is, the techniques according to the present disclosure may exhibit other effects apparent to those skilled in the art from the description herein, in addition to or in place of the above effects.

Further, the following configurations also fall within the technical scope of the present disclosure.

(1)

An information processing device, including:
an angle sequence derivation unit that derives at least one or more joint angle sequences of a manipulator corresponding to each of small regions, obtained by dividing a task space of a robot, in dimensions of position and orientation of a hand tip of the manipulator of the robot; and
a grouping unit that classifies, for each of the small regions, the joint angle sequences, corresponding to the small region, into at least one or more groups.
   (2)

The information processing device according to (1), wherein the grouping unit classifies the joint angle sequences into at least one or more groups, based on similarities between the joint angle sequences.

(3)

The information processing device according to (2), wherein the grouping unit classifies the joint angle sequences into at least one or more groups by using clustering processing.

(4)

The information processing device according to any one of (1) to (3), wherein the angle sequence derivation unit derives at least one or more of the joint angle sequences corresponding respectively to the small regions by deriving, by forward kinematics calculation, the small regions corresponding to the joint angle sequences repeatedly randomly sampled.

(5)

The information processing device according to (4), wherein the randomly sampled joint angle sequences are joint angle sequences that do not cause auto-interference of the manipulator.

(6)

The information processing device according to any one of (1) to (5), further including a data generation unit that generates, for each of small regions, redundancy data that creates a list of combination of identification information and a representative value of each of the groups included in the small region.

(7)

The information processing device according to (6), wherein the representative value is a value derived based on the joint angle sequence that belongs to the group.

(8)

The information processing device according to (7), wherein the representative value is a maximum manipulability of the joint angle sequence that belongs to the group.

(9)

The information processing device according to any one of (6) to (8), further including a map generation unit that generates a reachable range map indicating a reachability of the position and orientation of the hand tip corresponding to the small region, based on a sum of the representative values of the respective groups included in the redundancy data.

(10)

The information processing device according to (9), further including a robot position derivation unit that derives a standing position of the robot at which the hand tip can reach the position and orientation by using an inverse reachable range map obtained by inversely transforming the reachable range map.

(11)

The information processing device according to any one of (6) to (10), wherein the data generation unit creates a list, for each of the small regions, of combination of the identification information, the representative value, and even the joint angle sequence corresponding to the representative value.

(12)

The information processing device according to (11), further including a graph generation unit that generates, based on similarities between the joint angle sequences that belong to the groups, a graph structure in which the groups are used as nodes and connected by edges within the small regions and between the small regions.

(13)

The information processing device according to (12), further including a trajectory planning unit that plans a motion trajectory of the hand tip of the manipulator by searching the graph structure.

(14)

The information processing device according to any one of (1) to (13), wherein the small regions are represented by discretized six-dimensional voxels.

(15)

An information processing method, including: by a computing device, deriving at least one or more joint angle sequences of a manipulator corresponding to each of small regions, obtained by dividing a task space of a robot, in dimensions of position and orientation of a hand tip of the manipulator of the robot; and classifying, for each of the small regions, the joint angle sequences, corresponding to the small region, into at least one or more groups.

### REFERENCE SIGNS LIST

1 Robot
10 Main body
11 Sensor
20 Manipulator
21 Hand tip
22 Arm
30 Moving mechanism
100,110,120 Information processing device
101 Sampling unit
102 Angle sequence derivation unit
103 Grouping unit
104 Data generation unit
111 Map generation unit
112 Robot position estimation unit
121 Graph generation unit
122 Trajectory planning unit

1. An information processing device, comprising:
an angle sequence derivation unit that derives at least one or more joint angle sequences of a manipulator corresponding to each of small regions, obtained by dividing a task space of a robot, in dimensions of position and orientation of a hand tip of the manipulator of the robot; and
a grouping unit that classifies, for each of the small regions, the joint angle sequences, corresponding to the small region, into at least one or more groups.

2. The information processing device according to claim 1, wherein the grouping unit classifies the joint angle sequences into at least one or more groups, based on similarities between the joint angle sequences.

3. The information processing device according to claim 2, wherein the grouping unit classifies the joint angle sequences into at least one or more groups by using clustering processing.

4. The information processing device according to claim 1, wherein the angle sequence derivation unit derives at least one or more of the joint angle sequences corresponding respectively to the small regions by deriving, by forward kinematics calculation, the small regions corresponding to the joint angle sequences repeatedly randomly sampled.

5. The information processing device according to claim 4, wherein the randomly sampled joint angle sequences are joint angle sequences that do not cause auto-interference of the manipulator.

6. The information processing device according to claim 1, further comprising a data generation unit that generates, for each of the small regions, redundancy data that creates a list of combination of identification information and a representative value of each of the groups included in the small region.

7. The information processing device according to claim 6, wherein the representative value is a value derived based on the joint angle sequence that belongs to the group.

8. The information processing device according to claim 7, wherein the representative value is a maximum manipulability of the joint angle sequence that belongs to the group.

9. The information processing device according to claim 6, further comprising a map generation unit that generates a reachable range map indicating a reachability of the position and orientation of the hand tip corresponding to the small region, based on a sum of the representative values of the respective groups included in the redundancy data.

10. The information processing device according to claim 9, further comprising a robot position derivation unit that derives a standing position of the robot at which the hand tip can reach the position and orientation by using an inverse reachable range map obtained by inversely transforming the reachable range map.

11. The information processing device according to claim 6, wherein the data generation unit creates a list, for each of the small regions, of combination of the identification information, the representative value, and, in addition, the joint angle sequence corresponding to the representative value.

12. The information processing device according to claim 11, further comprising a graph generation unit that generates, based on similarities between the joint angle sequences that belong to the groups, a graph structure in which the groups are used as nodes and connected by edges within the small regions and between the small regions.

13. The information processing device according to claim 12, further comprising a trajectory planning unit that plans a motion trajectory of the hand tip of the manipulator by searching the graph structure.

14. The information processing device according to claim 1, wherein the small regions are represented by discretized six-dimensional voxels.

15. An information processing method, comprising: by a computing device,
deriving at least one or more joint angle sequences of a manipulator corresponding to each of small regions, obtained by dividing a task space of a robot, in dimensions of position and orientation of a hand tip of the manipulator of the robot; and
classifying, for each of the small regions, the joint angle sequences, corresponding to the small region, into at least one or more groups.
